(19) United States
(12) Patent Application Publication
(10) Pub. No.: US 2026/0126887 A1
(43) Pub. Date: May 7, 2026

(54) SYSTEMS AND METHODS FOR INTUITIVE NAVIGATION USING DYNAMIC CAROUSEL

(71) Applicant: Dell Products L.P., Round Rock, TX (US)

(72) Inventors: Vivekanandh Narayanasamy RAJAGOPALAN, Bangalore (IN); Bhavani ANANDAKRISHNAN, Chennai (IN)

(73) Assignee: Dell Products L.P., Round Rock, TX (US)

(21) Appl. No.: 18/936,249

(22) Filed: Nov. 4, 2024

(51) Int. Cl. G06F 3/0482

(52) U.S. Cl. CPC G06F 3/0482

(57) ABSTRACT

An information handling system may include a processor and a dynamic carousel control comprising a program of instructions embodied in non-transitory computer-readable media communicatively coupled to the processor and configured to, when read and executed by the processor, display to a display device a carousel interface comprising menu item selection buttons for a plurality of menu items, a navigation button for navigating the plurality of menu items, an options display portion configured to display information associated with a selected menu item from the plurality of menu items, and a list view activation button. The dynamic carousel control may also be configured to monitor interactions by a user with the carousel interface and in response to a user interaction with the list view activation button, display to the display device within the carousel interface a list view portion displaying the plurality of menu items in list form.

### TECHNICAL FIELD

The present disclosure relates in general to information handling systems, and more particularly to providing an improved user interface for a carousel user interface.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often include a display for displaying graphical and/or alphanumeric information to a user, and often include user interface input devices (e.g., a mouse and keyboard) allowing the user to interact with the display. In some information handling systems, an operating system or application may display a carousel interface, in which one menu item at a time may be highlighted from a list of menu items or options, and for which a user traditionally clicks on an arrow to scroll the display left or right or navigate to other menu items in order to exercise desired functionality.

While a traditional carousel interface allows for optimization of display space, it may display only a subset of items from a collection of items, creating many touch points for a user, and restricts a user to a single-item view or movement. Further, a traditional carousel interface only allows a user to access items sequentially to understand the options but does not allow a user to directly select another menu item.

### SUMMARY

In accordance with the teachings of the present disclosure, the disadvantages and problems associated with traditional approaches to carousel interfaces may be reduced or eliminated.

In accordance with embodiments of the present disclosure, an information handling system may include a processor and a dynamic carousel control comprising a program of instructions embodied in non-transitory computer-readable media communicatively coupled to the processor and configured to, when read and executed by the processor, display to a display device a carousel interface comprising menu item selection buttons for a plurality of menu items, a navigation button for navigating the plurality of menu items, an options display portion configured to display information associated with a selected menu item from the plurality of menu items, and a list view activation button. The program of instructions of the dynamic carousel control may also be configured to, when read and executed by the processor, monitor interactions by a user with the carousel interface and in response to a user interaction with the list view activation button, display to the display device within the carousel interface a list view portion displaying the plurality of menu items in list form.

In accordance with these and other embodiments of the present disclosure, a method may include displaying to a display device a carousel interface comprising menu item selection buttons for a plurality of menu items, a navigation button for navigating the plurality of menu items, an options display portion configured to display information associated with a selected menu item from the plurality of menu items, and a list view activation button. The method may also include monitoring interactions by a user with the carousel interface and in response to a user interaction with the list view activation button, displaying to the display device within the carousel interface a list view portion displaying the plurality of menu items in list form.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to display to a display device a carousel interface comprising menu item selection buttons for a plurality of menu items, a navigation button for navigating the plurality of menu items, an options display portion configured to display information associated with a selected menu item from the plurality of menu items, and a list view activation button. The instructions may further cause the processor to monitor interactions by a user with the carousel interface and in response to a user interaction with the list view activation button, display to the display device within the carousel interface a list view portion displaying the plurality of menu items in list form.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure;

FIG. 2 illustrates selected portions of an example user interface screen that may be displayed to a user of the information handling system shown in FIG. 1, in accordance with embodiments of the present disclosure; and

FIG. 3 illustrates a flow chart of an example method for implementing control of a dynamic carousel interface, in accordance with embodiments of the present disclosure.

### DETAILED DESCRIPTION

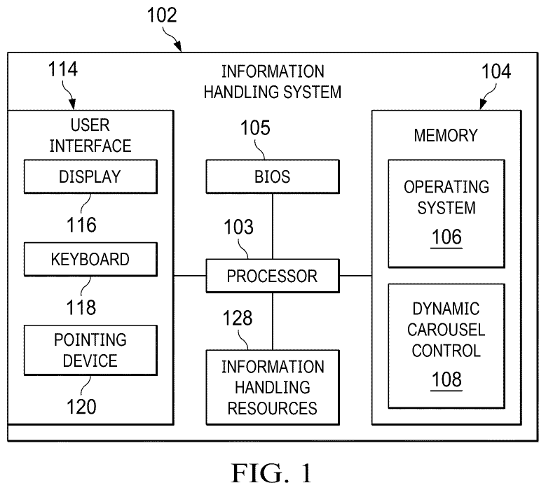

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

FIG. 1 illustrates a block diagram of selected components of an example information handling system 102, in accordance with embodiments of the present disclosure. In some embodiments, information handling system 102 may comprise or be an integral part of a server. In some embodiments, information handling system 102 may be a personal computer (e.g., a desktop computer or a portable computer). In other embodiments, information handling system 102 may comprise a mobile device (e.g., a smart phone, a tablet computing device, a handheld computing device, a personal digital assistant, or any other device that may be readily transported on a person of a user of such mobile device).

As depicted in FIG. 1, information handling system 102 may include a processor 103, a memory 104 communicatively coupled to processor 103, a user interface 114 communicatively coupled to processor 103, and one or more information handling resources 128 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, and/or another component of information handling system 102.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 102 is turned off.

As shown in FIG. 1, memory 104 may have stored therein an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

As shown in FIG. 1, memory 104 may also have stored therein a dynamic carousel control 108. Dynamic carousel control 108 may comprise one or more programs of instructions, which may run on operating system 106 as an application program or utility, and may be configured to control operation of a dynamic carousel interface displayed to a user via user interface 114, including processing of user interaction with the dynamic carousel interface and controlling the contents of the dynamic carousel interface displayed to the user, as described in greater detail below.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105.

User interface 114 may comprise any instrumentality or aggregation of instrumentalities by which a user may interact with information handling system 102. For example, user interface 114 may permit a user to input data and/or instructions into information handling system 102 (e.g., via a pointing device, keypad, keyboard, touch screen, microphone, camera, and/or other data input device), and/or otherwise manipulate information handling system 102 and its associated components. User interface 114 may also permit information handling system 102 to communicate data to a user (e.g., via a display device, speaker, and/or other data output device). As shown in FIG. 1, user interface 114 may include one or more of a display 116, keyboard 118, and pointing device 120.

Display 116 may comprise any suitable system, device, or apparatus configured to display human-perceptible graphical data and/or alphanumeric data to a user. For example, in some embodiments, display 116 may comprise a liquid crystal display.

Keyboard 118 may comprise any suitable system, device, or apparatus modeled after a typewriter keyboard or other keyboard which uses an arrangement of buttons or keys to act as mechanical levers or electronic switches for inputting data to information handling system 102.

Pointing device 120 may comprise any suitable system, device, or apparatus configured to allow a user to input spatial (i.e., continuous and multi-dimensional) data to information handling system 102. Examples of pointing device 120 may include a mouse, a touchpad, a pointing stick, and a trackpoint.

In addition to processor 103, memory 104, BIOS 105, and user interface 114, information handling system 102 may include one or more other information handling resources 128. Such an information handling resource 128 may include any component system, device or apparatus of an information handling system, including without limitation, a processor, bus, memory, I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

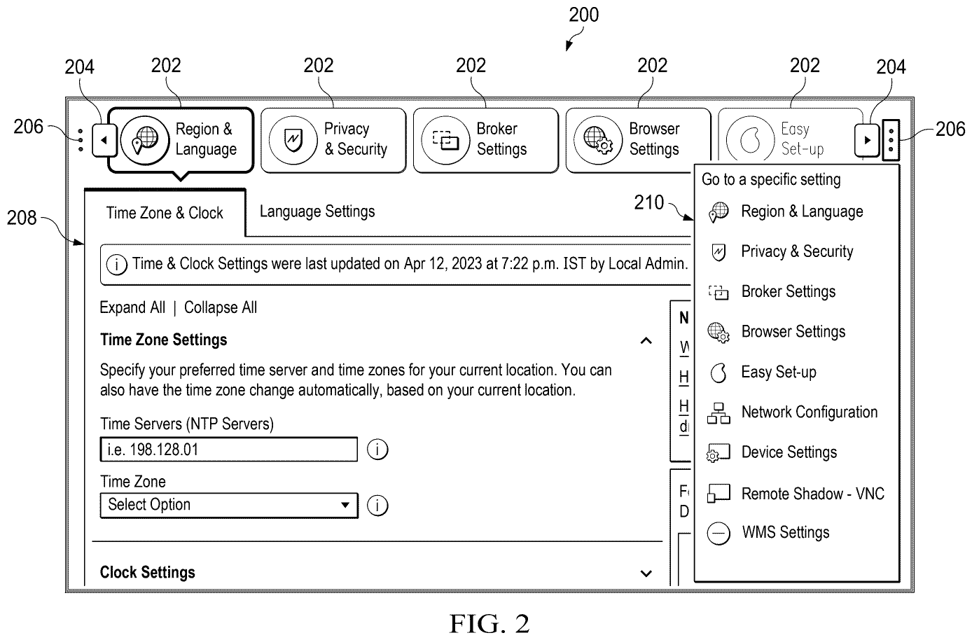

In operation, dynamic carousel control 108 may manage display and processing of user interface elements of a user interface screen, such as that shown in FIG. 2. FIG. 2 illustrates selected portions of an example user interface screen 200 for a dynamic carousel interface that may be displayed to a user of the information handling system shown in FIG. 1, in accordance with embodiments of the present disclosure.

As shown in FIG. 2, user interface screen 200 may include menu item selection buttons 202 for a plurality of menu items, navigation buttons 204, list view activation buttons 206, options display portion 208, and list view portion 210.

As in traditional approaches, dynamic carousel control 108 may control and update user interface screen 200 based on user interaction with menu item selection buttons 202 and navigation buttons 204. For example, in response to a user selection of a menu item button 202 (e.g., a user's click or other interaction with a menu item selection button 202), dynamic carousel control 108 may update user interface screen 200 to display within options display portion 208 various configuration options associated with the selected menu item selection button 202. As another example, the plurality of possible menu items may be more than can be supported by the width of user interface screen 200, and a user's interaction with a navigation button 204 may cause user interface screen 200 to sequentially scroll horizontally among the available menu items. For instance, clicking on the rightmost navigation button 204 may scroll to the right, causing the leftmost menu item button 202 to scroll off of user interface screen 200, shifting all other visible menu item buttons 202 leftward, and causing display of a new menu item button 202 as the rightmost menu item button 202.

In addition to providing traditional navigation of a carousel interface as described above, dynamic carousel control 108 may allow a user to interact with a list view activation button 206 in order to activate list view portion 210 to display all available menu items in a compact and scrollable format. Thus, each user interaction (e.g., click) with a list view activation button 206 may toggle between activation and deactivation of list view option portion 210. Further, when list view option portion 210 is activated, a user may interact with (e.g., click on) a specific menu item in the displayed list of list view option portion 210, and in response, dynamic carousel control 108 may update user interface screen 200 to display within options display portion 208 various configuration options associated with the selected menu item from list view option portion 210.

As shown in FIG. 2, each list view activation button 206 may be displayed in proximity to a corresponding navigation button 204. However, in some embodiments, a list view activation button 206 may be displayed elsewhere within user interface screen 200.

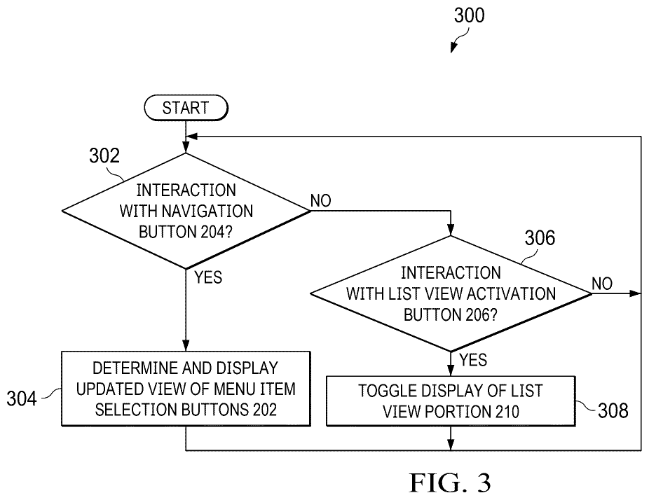

FIG. 3 illustrates a flow chart of an example method 300 for implementing control of a dynamic carousel interface, in accordance with embodiments of the present disclosure. According to some embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, dynamic carousel control 108 may determine whether a user interaction with a navigation button 204 has occurred. If a user interaction with a navigation button 204 has occurred, method 300 may proceed to step 304. Otherwise, method 300 may proceed to step 306.

At step 304, dynamic carousel control 108 may, responsive to the user interaction with a navigation button 204, determine the updated view (e.g., scroll left or scroll right) of menu item selection buttons 202 and display such updated view. After step 304, method 300 may proceed again to step 302.

At step 306, dynamic carousel control 108 may determine whether a user interaction with a list view activation button 206 has occurred. If a user interaction with a list view activation button 206 has occurred, method 300 may proceed to step 308. Otherwise, method 300 may proceed again to step 302.

At step 308, dynamic carousel control 108 may, responsive to the user interaction with a list view activation button 206, toggle display of list view portion 210 within user interface screen 200 (e.g., activating list view portion 210 if presently deactivated, deactivating list view portion 210 if presently activated). Further, when list view portion 210 is activated, dynamic carousel control 108 may process any interaction with list view portion 210 (e.g., user click on a menu item within list view portion 210) by updating user interface screen 200 in accordance with the user interaction. After completion of step 308, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented in whole or part using a variety of configurations of information handling system 102 and/or any other system operable to implement method 300. In certain embodiments, method 300 may be implemented partially or fully in software and/or firmware embodied in computer-readable media.

The systems and methods described herein may provide one or more advantages. For example, the systems and methods described herein may enable a carousel interface with traditional functionality of horizontally scrolling through menu list items while also offering a user the ability to display a list view that provides all carousel menu items in a compact and scrollable format. Such list view may provide the user with a comprehensive overview of all menu items without the need for traditional carousel navigation. Further, the transition between traditional navigation and the list view may be smooth and user-intuitive. Users may easily switch between the two approaches, maintaining context and preserving current position within the carousel.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor; and
a dynamic carousel control comprising a program of instructions embodied in non-transitory computer-readable media communicatively coupled to the processor and configured to, when read and executed by the processor:
display to a display device a carousel interface comprising:
menu item selection buttons for a plurality of menu items;
a navigation button for navigating the plurality of menu items;
an options display portion configured to display information associated with a selected menu item from the plurality of menu items; and
a list view activation button;
monitor interactions by a user with the carousel interface; and
in response to a user interaction with the list view activation button, display to the display device within the carousel interface a list view portion displaying the plurality of menu items in list form.

2. The information handling system of claim 1, wherein the dynamic carousel control is further configured to, in response to a user interaction with the list view activation button:
display the list view portion if the list view portion is not presently displayed; and
hide the list view portion if the list view portion is presently displayed.

3. The information handling system of claim 1, wherein the dynamic carousel control is further configured to, in response to a user interaction with a specific menu item displayed in the list view portion, update the options display portion associated with the specific menu item.

4. The information handling system of claim 1, wherein the list view activation button is displayed in proximity with the navigation button.

5. A method comprising:
displaying to a display device a carousel interface comprising:
menu item selection buttons for a plurality of menu items;
a navigation button for navigating the plurality of menu items;
an options display portion configured to display information associated with a selected menu item from the plurality of menu items; and
a list view activation button;
monitoring interactions by a user with the carousel interface; and
in response to a user interaction with the list view activation button, displaying to the display device within the carousel interface a list view portion displaying the plurality of menu items in list form.

6. The method of claim 5, further comprising, in response to a user interaction with the list view activation button:
displaying the list view portion if the list view portion is not presently displayed; and
hiding the list view portion if the list view portion is presently displayed.

7. The method of claim 5, further comprising, in response to a user interaction with a specific menu item displayed in the list view portion, updating the options display portion associated with the specific menu item.

8. The method of claim 5, further comprising displaying the list view activation button in proximity with the navigation button.

9. An article of manufacture comprising:
a non-transitory computer-readable medium; and
computer-executable instructions carried on the computer-readable medium, the instructions readable by a processor, the instructions, when read and executed, for causing the processor to:
display to a display device a carousel interface comprising:
menu item selection buttons for a plurality of menu items;
a navigation button for navigating the plurality of menu items;
an options display portion configured to display information associated with a selected menu item from the plurality of menu items; and
a list view activation button;
monitor interactions by a user with the carousel interface; and
in response to a user interaction with the list view activation button, display to the display device within the carousel interface a list view portion displaying the plurality of menu items in list form.

10. The article of claim 9, the instructions for further causing the processor to:
display the list view portion if the list view portion is not presently displayed; and
hide the list view portion if the list view portion is presently displayed.

11. The article of claim 9, the instructions for further causing the processor to, in response to a user interaction with a specific menu item displayed in the list view portion, update the options display portion associated with the specific menu item.

12. The article of claim 9, the instructions for further causing the processor to display the list view activation button in proximity with the navigation button.
